(19) United States
(12) Patent Application Publication
(10) Pub. No.: US 2025/0164636 A1
(43) Pub. Date: May 22, 2025

(54) AUTOMOTIVE TRAILER PATH PREDICTION

(71) Applicant: Panasonic Automotive Systems Company of America, Division of Panasonic Corporation of North America, PEACHTREE CITY, GA (US)

(72) Inventors: SAKTHIVEL GANESAMOORTHY, NOVI, MI (US); HANK CHAVERS, LEWISVILLE, TX (US); HANS A. TROEMEL, JR., SHARPSBURG, GA (US); JIN WOO JUNG, JOHNS CREEK, GA (US)

(21) Appl. No.: 18/947,798

(22) Filed: Nov. 14, 2024

Related U.S. Application Data
(60) Provisional application No. 63/600,509, filed on Nov. 17, 2023.

(51) Int. Cl. G01S 13/931; B60R 1/26; G01S 13/74; G01S 13/86

(52) U.S. Cl. CPC G01S 13/931; B60R 1/26; G01S 13/74; G01S 13/867; B60R 2300/8086; G01S 2013/9317; G01S 2013/9329

(57) ABSTRACT

A trailer path prediction arrangement for a motor vehicle includes an ultra-wideband responder mounted on a trailer that is coupled to the motor vehicle. An ultra-wideband initiator is mounted on the motor vehicle and senses a distance and angle between the ultra-wideband initiator and the ultra-wideband responder. An electronic processor is communicatively coupled to the ultra-wideband initiator and is mounted on the motor vehicle. The electronic processor predicts a path to be taken by the trailer. The predicting is dependent upon the sensed distance and angle between the ultra-wideband initiator and the ultra-wideband responder.

### CROSS-REFERENCED TO RELATED APPLICATIONS

This application claims benefit of U.S. Provisional Application No. 63/600,509, filed on Nov. 17, 2023, the disclosure of which is hereby incorporated by reference in its entirety for all purposes.

### BACKGROUND OF THE INVENTION

### 1. Field of the Invention

The present invention relates to predicting the path of a trailer pulled by a motor vehicle.

### 2. Description of the Related Art

Existing approaches use sensors like cameras and inertial measurement unit (IMU) sensors along with software algorithms for predicting the path of a trailer. At present there are several challenges in predicting the path of a lengthy trailer connected to a vehicle. Aside from IMU and camera sensors, few wireless technologies like Bluetooth/Wi-Fi are in place to facilitate trailer path prediction. Bluetooth or Wi-Fi cannot provide centimeter level accuracy, which is a disadvantage for localization. Software algorithm techniques are being used to localize the trailer movement by fusing the available information and predicting the trajectory.

At present UWB sensors are utilized only for indoor localization.

### SUMMARY OF THE INVENTION

The invention may enable better path predictions to be made for a trailer. The invention may make precise predictions and ease the manual calibration process/procedure for trailer-connected cameras. The invention can improve the drawing of rear-view grid lines in the vehicle infotainment system. The invention may improve synchronization and calibration of the camera feeds from multiple cameras attached in a trailer.

The invention may use a camera, an IMU sensor, and an ultra-wideband (UWB) sensor to provide centimeter-level accuracy for trailer path prediction.

This invention may relate to applying UWB sensors to automotive trailer nodes to improve the location accuracy and to better predict the trailer trajectory for the driver view in the infotainment system. Adding a UWB sensor may enhance the localization performance. A UWB sensor can provide “centimeter” level accuracy, which may improve the “trailer trajectory” prediction model. The UWB sensor can improve the performance of “image stitching” in a surround view system. The invention may provide the following two types of systems:

1. A UWB system with an initiator mounted on a receiver of a motor vehicle and a responder mounted on a trailer, wherein the UWB system can improve a prediction of a trailer path.

System of 1 above, which can be used to improve the accuracy of camera path grid lines as presented to the user.

System of 1 above, which can be used to determine the trailer trajectory automatically in case of any emergency, where a trailer is being dislocated due to a mechanical failure or external events.

System of 1 above, which can be used to restrict the trailer movement within a defined zone/perimeter.

System of 1 above, which can be used to collect data about trailer movement patterns and monitor the movement patterns for indications of any wear and tear, and thereby facilitate diagnosis of the wear and tear.

2. A UWB system in a multi camera automotive trailer and receiver system which can improve the surround view image stitching.

System of 2 above, which can be used to precisely determine the location of each camera attached to a trailer.

System of 2 above, which can be used in a surround view system for camera synchronization.

System of 2 above, which can be used to automatically locate the camera and identify the camera details to improve the user experience.

The invention comprises, in one form thereof, a trailer path prediction arrangement for a motor vehicle. The arrangement includes an ultra-wideband responder mounted on a trailer that is coupled to the motor vehicle. An ultra-wideband initiator is mounted on the motor vehicle and senses a distance between the ultra-wideband initiator and the ultra-wideband responder. An electronic processor is communicatively coupled to the ultra-wideband initiator and is mounted on the motor vehicle. The electronic processor predicts a path to be taken by the trailer. The predicting is dependent upon the sensed distance and angle between the ultra-wideband initiator and the ultra-wideband responder.

The invention comprises, in another form thereof, a method for predicting a path of a trailer that is coupled to a motor vehicle. The method includes transmitting a request signal from an ultra-wideband initiator mounted on the motor vehicle to an ultra-wideband responder on the trailer. In response to the request signal, a response signal is transmitted from the ultra-wideband responder to the ultra-wideband initiator. A distance between the ultra-wideband initiator and the ultra-wideband responder is sensed based on a time period between the transmitting of the request signal and the ultra-wideband initiator receiving the response signal. The path to be taken by the trailer is predicted dependent upon the sensed distance and angle between the ultra-wideband initiator and the ultra-wideband responder.

The invention comprises, in yet another form thereof, a trailer monitoring arrangement for a motor vehicle. The arrangement includes at least three cameras mounted on a trailer that is coupled to the motor vehicle. Each camera includes a respective ultra-wideband responder. An ultra-wideband initiator is mounted on the motor vehicle and senses a plurality of distance and angles. Each distance is between the ultra-wideband initiator and a respective one of the ultra-wideband responders. An electronic processor is communicatively coupled to the ultra-wideband initiator and is mounted on the motor vehicle. The electronic processor monitors movement of the trailer based on the sensed distance and angles between the ultra-wideband initiator and the ultra-wideband responders. The electronic processor causes a driver of the motor vehicle to be notified in the event that the monitored movement of the trailer is outside of a normal range.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of an automotive trailer path prediction arrangement of the present invention.

FIG. 2 is a plot illustrating the time-of-flight concept as applied to the UWB sensor of FIG. 1.

FIG. 3 is a block diagram of one embodiment of a method of the present invention for predicting and displaying a path of a trailer.

FIG. 4 is a flow chart of one embodiment of a method of the present invention for monitoring a path of a trailer.

FIG. 5 is a schematic diagram of a localization arrangement for a trailer having multiple cameras.

FIG. 6 is a schematic diagram of trailer movement depending on an angle between the motor vehicle and the trailer.

FIG. 7 is a flow chart of one embodiment of a method of the present invention for predicting a path of a trailer that is coupled to a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

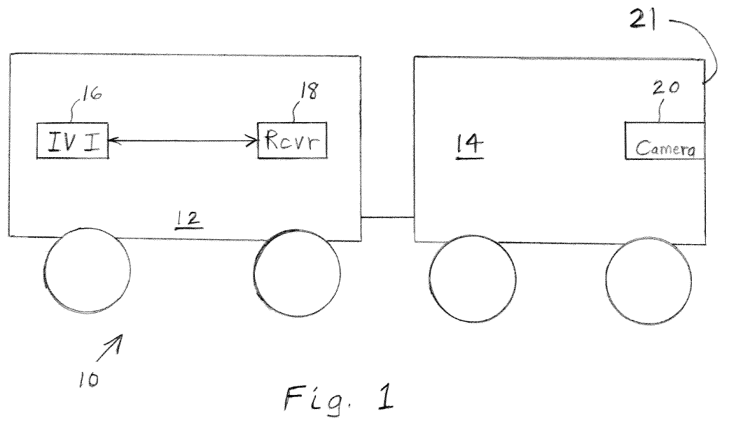

FIG. 1 illustrates one embodiment of an automotive trailer path prediction arrangement 10 of the present invention, including a motor vehicle 12 pulling a trailer 14. Motor vehicle 12 includes an in-vehicle infotainment system 16 in bi-directional communication with a wireless receiver 18. Trailer 14 includes a camera module 20.

Receiver 18 includes a wireless module for pairing, connecting and communicating with camera module 20. Receiver 18 may process the camera feed and localize trailer 14. Receiver 18 may output the results to infotainment system 16. Receiver 18 includes a UWB radar anchor for improving the location accuracy.

Camera module 20 may include an IMU sensor for detecting the trailer movement and direction. Camera module 20 may include a wireless module for pairing, connecting and transmitting the video feed. Camera module 20 includes a UWB radar tag for improving the location accuracy.

Camera module 20 is shown as being mounted on a rear end 21 of trailer 14. In another embodiment, two additional camera modules (not shown), which may function identically to camera module 20, are mounted on respective opposite lateral sides of trailer 14.

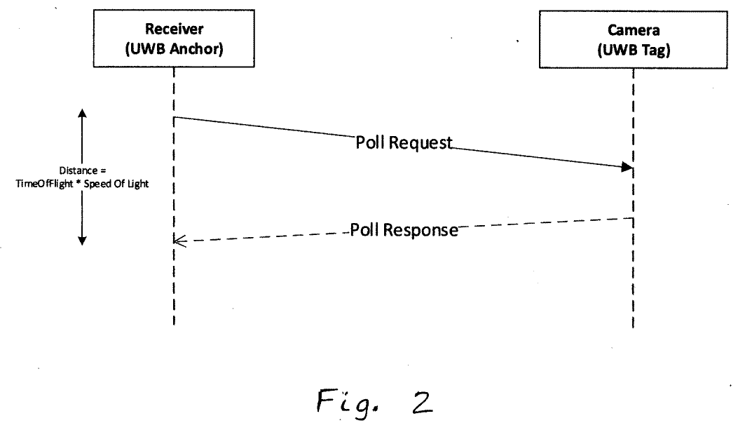

With regards to positioning based on the UWB sensor, The UWB anchor may reside in receiver 18. The UWB tags may reside in camera module 20. As illustrated in FIG. 2, UWB sensor-based ranging works on the “time of flight” principle. It is possible to measure the “angle of arrival” and location of each tag. The UWB anchor and tags may range, or measure, the exact distance between them. The ranging may be accomplished through Time of Flight (ToF), the time it takes for a pulse to get from point A to point B.

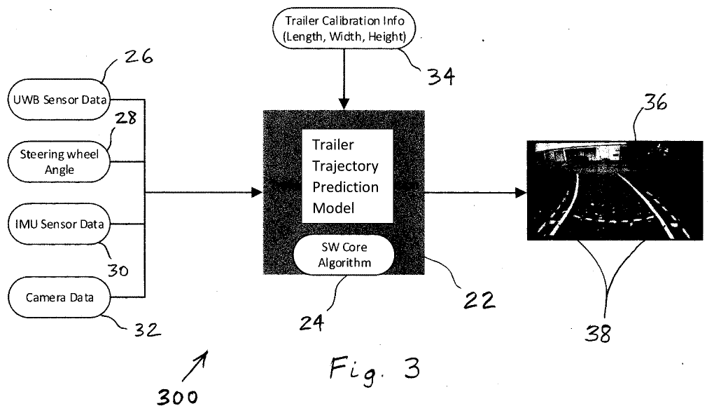

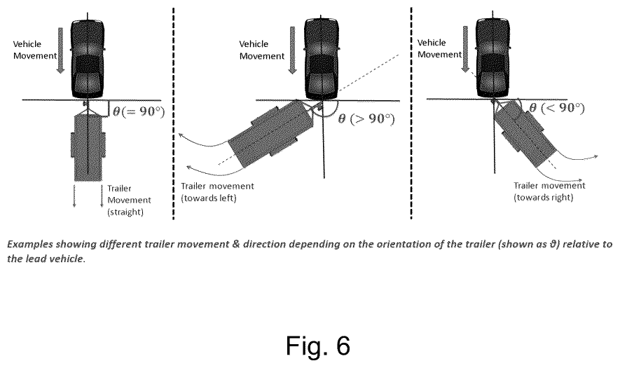

With regard to rear camera trailer trajectory planning, utilizing the location and angle of arrival from the UWB sensor along with inputs from the steering wheel can result in a better prediction model. FIG. 3 illustrates one embodiment of a method 300 of the present invention for predicting and displaying a path of trailer 14. A trailer trajectory prediction model 22 having a software core algorithm 24 runs within infotainment system 16. Trailer trajectory prediction model 22 receives data 26 from the UWB sensor; steering wheel angle data 28, which indicates the direction in which the front wheels are oriented; data 30 from the IMU sensor; image data 32 from camera 20; and trailer calibration information 34, such as the length, width and height of trailer 14. UWB sensor data 26 may include a distance between receiver 18 and camera 20, and angles of arrival (defined below with reference to FIG. 6). Based on these inputs, model 22 may output a prediction of the path of trailer 14. This prediction may be embodied in an image 36 that may be displayed to a driver of vehicle 12. Image 36 may include an image captured by camera 20 having a lines or curves 38 representing the predicted path of the tires of trailer 14 superimposed thereon.

The trajectory of trailer 14 may be automatically monitored to detect failures or safety emergencies associated with trailer 14. In case of critical failures where trailer 14 is dislocated due to external events, with the location information from the UWB device it is possible to detect the trailer movement automatically and alert the driver. Such external events that dislocate trailer 14 may include something colliding with trailer 14; trailer 14 hitting a pothole, or the failure of some component of trailer 14 or of the linkage between vehicle 12 and trailer 14, for example.

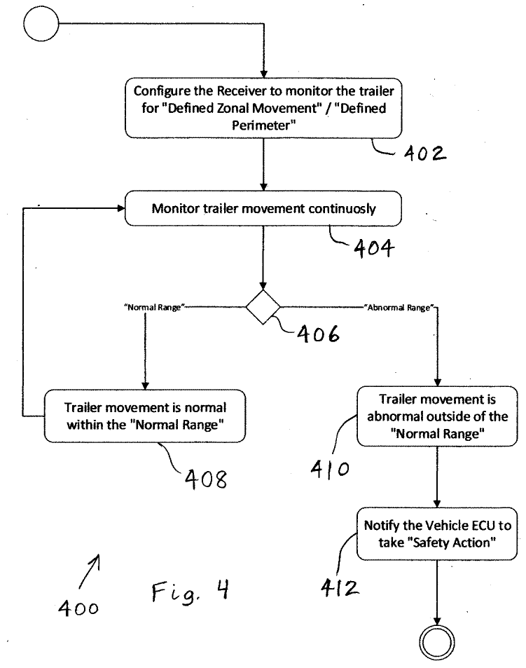

FIG. 4 illustrates one embodiment of a method 400 of the present invention for monitoring a path of trailer 14. In a first step 402, receiver 18 and/or infotainment system 16 are configured to monitor the movements of the perimeter of trailer 14 based on data received from all the sources shown in FIG. 3. Next, in step 404, movements of trailer 14 are monitored continuously by receiver 18 and/or infotainment system 16. In a next step 406, it is determined whether movement of trailer 14 is within a normal range (408), or is abnormal and outside of the normal range (410). If the trailer movement is within a normal range, then operation returns to step 404. However, if it is determined that the trailer movement is abnormal and outside of the normal range (410), then in step 412, the ECU of vehicle 12 is notified of the abnormality so that a “safety action” may be taken. An example of such a “safety action” may be to notify the driver of vehicle 12, visually and/or audibly, of the abnormality. Another example of a “safety action” is to automatically slow down vehicle 12 and possibly to drive vehicle 12 away from other vehicles in order to avoid a collision therewith.

In the embodiment in which the trailer includes multiple cameras, each camera may include a UWB tag and may function as a node for trajectory planning. The location of each node may be periodically determined. The location of each node may be triangulated with respect to the location of receiver 18.

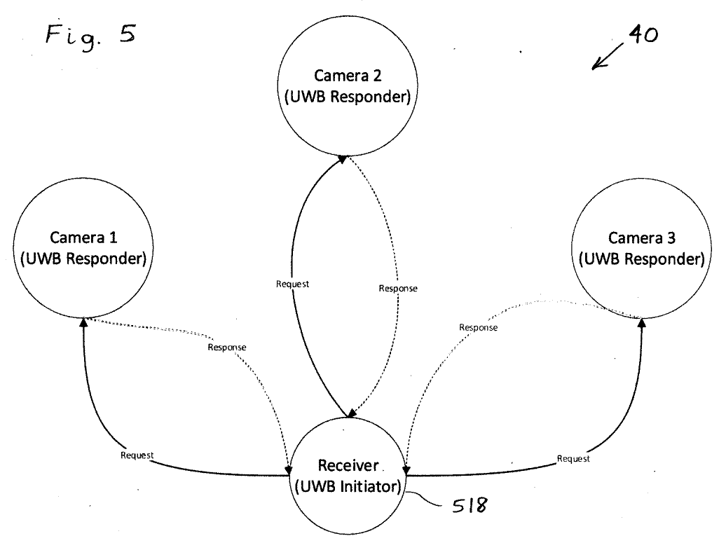

FIG. 5 illustrates a localization arrangement 40 for a trailer having multiple cameras. Arrangement 40 includes a receiver 518 having a UWB initiator or anchor. Arrangement 40 also includes camera 1, camera 2 and camera 3, each having a respective UWB responder or tag. Receiver 518 wirelessly transmits a respective request to each camera, and each camera transmits a respective response to receiver 518. Receiver 518 may calculate the distances between receiver 518 and each respective camera based on the time elapsed between the request being transmitted by receiver 518 and the response being received by receiver 518.

The trailer's future movement, knowledge of which is required to do the correct trailer path prediction, depends on how the trailer is oriented to the vehicle, which changes dynamically over time. FIG. 6 shows how the orientation of the trailer relative to the car (angle θ) impacts the trailer's movement when the vehicle is in motion. In FIG. 6, the vehicle in all three cases moves the same (backing up straight) meaning the steering wheel angle is also the same. However, as can be clearly seen in FIG. 6, depending on whether θ is larger or smaller than 90 degrees, the direction of the trailer movement is opposite. Therefore, it can be seen that the orientation of the trailer to the vehicle (shown as angle θ in the example of FIG. 6) is one of the key parameters for correctly predicting the trailer movement in the future. However, the detailed prediction algorithm that uses this orientation or angle is beyond the scope of this invention. This invention provides a way to ascertain the orientation (or angle θ) that is required for trailer path prediction by use of UWB sensors.

It is possible to optimize, based on the fixed dimensions of the trailer, the number of UWB sensors required to predict the trailer's trajectory.

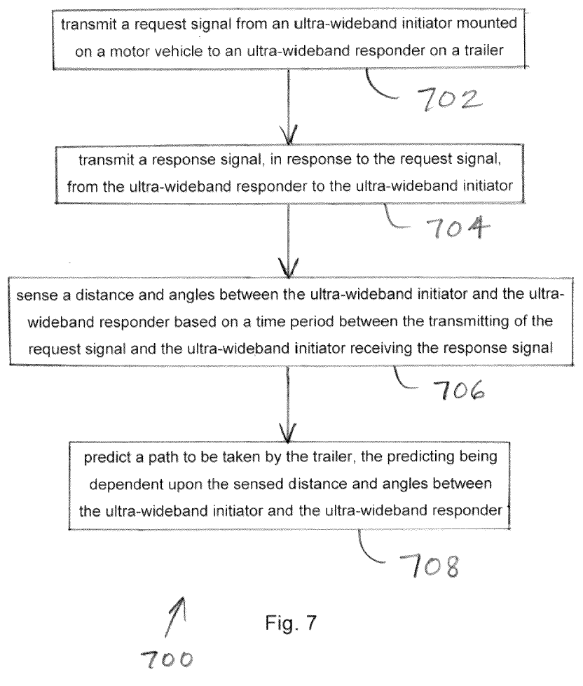

FIG. 7 illustrates one embodiment of a method 700 of the present invention for predicting a path of a trailer that is coupled to a motor vehicle. In a first step 702, a request signal from an ultra-wideband initiator mounted on the motor vehicle is transmitted to an ultra-wideband responder on the trailer. For example, UWB initiator of receiver 18 mounted on vehicle 12 wirelessly transmits a request signal to a UWB responder of camera 20 on trailer 14, as shown in FIG. 5.

Next, in step 704, in response to the request signal, a response signal is transmitted from the ultra-wideband responder to the ultra-wideband initiator. For example, in response to the request signal, the UWB responder of camera 20 wirelessly transmits a response signal to UWB initiator of receiver 18, as shown in FIG. 5.

In a next step 706, a distance and angles between the ultra-wideband initiator and the ultra-wideband responder are sensed based on a time period between the transmitting of the request signal and the ultra-wideband initiator receiving the response signal. For example, receiver 518 may calculate the distance and angles between receiver 518 and the camera based on the time elapsed between the request being transmitted by receiver 518 and the response being received by receiver 518. It is possible for the distance between the receiver and the camera to uniquely define the angle between the receiver and the camera, just as the length of the base of an isosceles triangle uniquely defines the angle between the equal sides of the triangle, given that the lengths of the equal sides are known.

In a final step 708, the path to be taken by the trailer is predicted. The predicting is dependent upon the sensed distance and angles between the ultra-wideband initiator and the ultra-wideband responder. For example, based on a distance between receiver 18 and camera 20, and angles of arrival, model 22 may output a prediction of the path of trailer 14.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A trailer path prediction arrangement for a motor vehicle, the arrangement comprising:
an ultra-wideband responder sensor configured to be mounted on a trailer that is coupled to the motor vehicle;
an ultra-wideband initiator sensor configured to be mounted on the motor vehicle and to sense:
a distance between the ultra-wideband initiator sensor and the ultra-wideband responder sensor; and
an angle of arrival between the motor vehicle and the trailer; and
an electronic processor communicatively coupled to the ultra-wideband initiator and configured to:
be mounted on the motor vehicle; and
predict a path to be taken by the trailer, the predicting being dependent upon the sensed distance between the ultra-wideband initiator sensor and the ultra-wideband responder sensor and the sensed angle of arrival.

1. The arrangement of claim 1 further comprising a wireless receiver configured to be mounted on the motor vehicle and including both the electronic processor and the ultra-wideband initiator sensor.

2. The arrangement of claim 1 further comprising a rearview camera configured to be mounted on the trailer, the ultra-wideband responder being mounted on the camera, the electronic processor being configured to predict the path to be taken by the trailer dependent upon image data received from the camera and a relative trajectory between the ultra-wideband sensors.

3. The arrangement of claim 3 further comprising a display screen mounted on the motor vehicle, the display screen being configured to present images dependent upon the predicted path to be taken by the trailer and dependent upon images captured by the rearview camera and a relative trajectory between the ultra-wideband sensors.

4. The arrangement of claim 1 further comprising a steering wheel angle sensor configured to be mounted on the motor vehicle, the electronic processor being configured to predict the path to be taken by the trailer dependent upon data received from the steering wheel angle sensor and a change in trajectory of the ultra-wideband sensors.

5. The arrangement of claim 1 further comprising an inertial measurement unit sensor, the electronic processor being configured to predict the path to be taken by the trailer dependent upon data received from the inertial measurement unit sensor and a change in trajectory of the ultra-wideband sensors.

6. The arrangement of claim 1 wherein the electronic processor is configured to predict the path to be taken by the trailer dependent upon trailer calibration data including a length, width and height of the trailer.

7. A method for predicting a path of a trailer that is coupled to a motor vehicle, the method comprising:
transmitting a request signal from an ultra-wideband initiator mounted on the motor vehicle to an ultra-wideband responder on the trailer;
transmitting a response signal, in response to the request signal, from the ultra-wideband responder to the ultra-wideband initiator;
sensing a distance and angles between the ultra-wideband initiator and the ultra-wideband responder based on a time period between the transmitting of the request signal and the ultra-wideband initiator receiving the response signal; and
predicting the path to be taken by the trailer, the predicting being dependent upon the sensed distance and angles between the ultra-wideband initiator and the ultra-wideband responder.

8. The method of claim 8 wherein the ultra-wideband initiator is included in a wireless receiver mounted on the motor vehicle, the predicting being performed by an electronic processor included in the wireless receiver.

9. The method of claim 8 further comprising capturing images with a rearview camera mounted on the trailer, the ultra-wideband responder being mounted on the rearview camera, the path to be taken by the trailer being predicted dependent upon image data received from the rearview camera and a change in trajectory of the ultra-wideband sensors.

10. The method of claim 10 further comprising presenting images on a display screen in the motor vehicle, the presented images being dependent upon the predicted path to be taken by the trailer and dependent upon images captured by the rearview camera and the change in trajectory of the ultra-wideband sensors.

11. The method of claim 8 further comprising sensing a steering wheel angle, the predicting of the path to be taken by the trailer being dependent upon the sensed steering wheel angle and a change in trajectory of the ultra-wideband sensors.

12. The method of claim 8 further comprising providing an inertial measurement unit sensor in the motor vehicle, the predicting of the path to be taken by the trailer being dependent upon data received from the inertial measurement unit sensor and a change in trajectory of the ultra-wideband sensors.

13. The method of claim 8 wherein the predicting of the path to be taken by the trailer is dependent upon trailer calibration data including a length, width and height of the trailer.

14. A trailer monitoring arrangement for a motor vehicle, the arrangement comprising:
at least three cameras configured to be mounted on a trailer that is coupled to the motor vehicle, each said camera including a respective ultra-wideband responder;
an ultra-wideband initiator configured to be mounted on the motor vehicle and to sense a plurality of distance and angles, each said distance being between the ultra-wideband initiator and a respective one of the ultra-wideband responders; and
an electronic processor communicatively coupled to the ultra-wideband initiator and configured to:
be mounted on the motor vehicle;
monitor movement of the trailer based on the sensed distance and angles between the ultra-wideband initiator and the ultra-wideband responders; and
cause a driver of the motor vehicle to be notified in the event that the monitored movement of the trailer is outside of a normal range.

15. The arrangement of claim 15 wherein a first of the cameras is mounted on a rear end of the trailer, a second of the cameras is mounted on a left lateral side of the trailer, and a third of the cameras is mounted on a right lateral side of the trailer.

16. The arrangement of claim 15 wherein the electronic processor is configured to predict the path to be taken by the trailer dependent upon image data received from the cameras and a change in trajectory of the ultra-wideband sensors.

17. The arrangement of claim 17 further comprising a display screen mounted on the motor vehicle, the display screen being configured to present images dependent upon the predicted path to be taken by the trailer and dependent upon images captured by the cameras and a change in trajectory of the ultra-wideband sensors.

18. The arrangement of claim 18 further comprising a steering wheel angle sensor configured to be mounted on the motor vehicle, the electronic processor being configured to predict the path to be taken by the trailer dependent upon data received from the steering wheel angle sensor and the change in trajectory of the ultra-wideband sensors.

19. The arrangement of claim 19 further comprising an inertial measurement unit sensor, the electronic processor being configured to predict the path to be taken by the trailer dependent upon data received from the inertial measurement unit sensor and the change in trajectory of the ultra-wideband sensors.
